(19) United States
(12) Patent Application Publication
(10) Pub. No.: US 2004/0027752 A1
(43) Pub. Date: Feb. 12, 2004

(54) Method and apparatus for controlling a startup signal during a brownout

(76) Inventors: Dennis James Craton, Douglasville, GA (US); Benny Lima, Snellville, GA (US)

Correspondence Address: LSI LOGIC CORPORATION, 1621 BARBER LANE, MS: D-106 LEGAL, MILPITAS, CA, 95035, US

(21) Appl. No.: 10/216,018

(22) Filed: Aug. 8, 2002

(51) Int. Cl. H02H 3/24; H02H 3/20

(52) U.S. Cl. 361/90

(57) ABSTRACT

Apparatus and methods for controlling a startup signal during a brownout. The invention controls the startup of a signal during the brownout using a monitor circuit and a control circuit. The startup signal is used in conjunction with a soft start feature to regulate power. The monitor circuit is configured for monitoring an input signal to the circuit and for providing a control signal in response to a change in the voltage level of the input signal. The control circuit is configured for receiving the control signal from the monitor circuit to control the startup signal during the brownout. The control circuit may control the startup signal with a transistor by electrically grounding the startup signal such that a capacitor may discharge during the brownout. The control circuit may prevent undesirable triggering of over-current protection circuitry within the regulator.

### BACKGROUND OF THE INVENTION

1. Field of the Invention

The present invention is generally directed toward controlling a startup signal during a “brownout”. More specifically, the present invention relates to controlling the startup signal during the brownout of a regulator that controls power to devices.

2. Discussion of Related Art

Many power supply devices regulate power to other devices. One such device is a Peripheral Component Interconnect (PCI) card electrically connected to a motherboard to receive power through an expansion board slot. A device receives power from a regulator that monitors current drawn by the device to control, or regulate, the power to the device. The regulator also functions as a circuit breaker to disconnect power from the device when the current drawn exceeds predetermined limits.

During “startup” of the device, the device may rapidly draw current and create a current spike that is greater than steady state operating current requirements. The current spike triggers over-current protection circuitry in the regulator to disconnect the power to the device. However, many devices require voltages that differ from those supplied by the regulators.

A typical regulator, such as a voltage regulator, employs a “soft start” feature that causes voltage at the output of the voltage regulator to “ramp up” in a controllable manner. The controllable voltage ramp reduces current spikes at startup of the device. The voltage regulator, therefore, does not trigger the over-current protection circuitry during startup of the device.

The soft start feature of the voltage regulator is typically implemented with a capacitor. The voltage regulator charges the capacitor with a fixed current, a startup signal, for example. The ramp up period of the voltage regulator is, therefore, the duration necessary for charging the capacitor with the fixed current. Once the capacitor is charged, the soft start feature is disabled such that the device relies on the over-current protection circuitry for protection against current spikes. While the device does not become fully operational until the capacitor is fully charged, it cannot draw enough current to trigger the over-current protection circuitry. Thus, in this startup mode, the voltage regulator protects the device from over-current damage.

Problems can occur during a brownout of power. The brownout is a temporary power outage or power shortage to the device during normal operation of the device. If the duration of the brownout is shorter than the duration for the capacitor to discharge, a current spike can occur as the device draws current from the voltage regulator. For example, during normal operation, a device draws current from the voltage regulator. A short interruption to that current flow starts the capacitor to discharge. However, if the power returns before the capacitor discharges, the device may draw more current from the voltage regulator to maintain its operable state. The device, therefore, can create a current spike and trigger the over-current protection circuitry, since the soft start feature of the voltage regulator is disabled. As a result, the over-current protection circuitry will shut down the device, perhaps in an undesirable manner.

While brownouts to power can occur often, shutting down a device may not be desirable. Some systems need full time operation of the devices; once over-protection circuitry shuts down a particular device, the device must be restarted. Restarting the device can incur an inordinate amount of time that some systems cannot afford. For example a device experiences a shut down caused by an associated brownout, the function that the device serves is subsequently shut down until the device is restarted. The time delay in such a system may not be acceptable. Therefore, as evident from the above discussion, a need exists for improved structures and methods for controlling a startup signal during a brownout.

### SUMMARY OF THE INVENTION

The present invention solves the above and other problems and advances the state of the useful arts by providing an apparatus and a method for controlling a startup signal during a brownout. More specifically, the present invention provides for controlling the startup signal during the brownout of power supplies that supply power to devices. A device receives power through a regulator that may employ a soft start feature using the startup signal to assist with power regulation during startup of the device.

In one exemplary preferred embodiment of the invention, a circuit controls the startup signal during the brownout. The circuit includes a monitor circuit and a control circuit. The monitor circuit is configured for monitoring an input signal to the circuit and for providing a control signal in response to a change in the input signal. The control circuit is configured for receiving the control signal from the monitor circuit to control the startup signal during the brownout. The brownout may occur during normal operation of the device and may undesirably trigger over-current protection circuitry to shut down the device. The brownout may include a shortage of power such that the soft start feature of a regulator is not re-enabled. The preferred embodiment of the invention may, therefore, operate to relieve shortcomings of the regulator during the brownout.

In another exemplary preferred embodiment of the invention, the monitor circuit includes an operational amplifier and/or a comparator for monitoring the input signal and providing a subsequent control signal. For example, the voltage level of the input signal may be compared to a reference voltage level to determine an appropriate control signal to output. The operational amplifier may provide a continuous voltage waveform for the control signal, whereas the comparator may provide a discrete voltage waveform for the control signal. The discrete and/or continuous voltage waveforms may be implemented as a matter of design choice. Those skilled in the art understand functional characteristics of operational amplifiers and comparators.

In another exemplary preferred embodiment of the invention, the control circuit includes a switching circuit and a capacitor. The switching circuit may be configured for receiving the control signal to control the startup signal during the brownout. The capacitor may have a first conduction terminal coupled for receiving the startup signal and a second conduction terminal coupled for receiving a ground reference potential. For example, as the monitor circuit determines that a voltage level of the input signal has decreased beyond a predetermined reference voltage level (e.g., as the device draws too much current), the monitor circuit outputs an appropriate control signal to the switching circuit. The switching circuit may conduct, or “short”, the current of the startup signal to the ground reference potential in response to receiving the control signal. The amount of current conducted to the ground reference potential may be related to the voltage level of the control signal (e.g., a discrete voltage level from the comparator causing the switching circuit to completely conduct the current of the startup signal to the ground reference potential and the continuous voltage level from the operational amplifier causing the switching circuit to partially and/or gradually conduct the current of the startup signal to the ground reference potential). In another exemplary preferred embodiment of the invention, the switching circuit includes a transistor having a control terminal coupled for receiving the control signal, a first conduction terminal coupled for receiving the startup signal, and a second conduction terminal coupled for receiving the ground reference potential. In another exemplary preferred embodiment of the invention, the transistor is a Metal Oxide Semiconductor Field Effect Transistor (MOSFET) configured for receiving the control signal to short the startup signal to the ground reference potential during the brownout and to charge the capacitor with the startup signal during startup and/or normal operation of the circuit.

In another exemplary preferred embodiment of the invention, the circuit includes a signal regulator configured for receiving the input signal and for providing the startup signal. The signal regulator may generate the startup signal as the device starts operating and drawing current from the circuit. The startup signal may charge the capacitor with a fixed current to controllably ramp up the output voltage. The capacitor may prevent the device from drawing too much current from the circuit and, thereby, creating an associated current spike.

In one aspect of the invention, a circuit controls a startup signal during a brownout, wherein the startup signal assists with power regulation. The circuit includes a monitor circuit configured for monitoring an input signal to the circuit and having an output coupled for providing a control signal. The circuit also includes a control circuit configured for receiving the control signal to control the startup signal during the brownout.

In another aspect of the invention, the monitor circuit includes an operational amplifier having a first input coupled for receiving a reference signal, a second input coupled for receiving the input signal, and an output coupled for providing the control signal.

In another aspect of the invention, the monitor circuit includes a comparator having a first input coupled for receiving a reference signal, a second input coupled for receiving the input signal, and an output coupled for providing the control signal.

In another aspect of the invention, the circuit comprises a signal regulator having an input coupled for receiving the input signal and an output coupled for providing the startup signal.

In another aspect of the invention, the control circuit includes a switching circuit having a first input coupled for receiving the startup signal, a second input coupled for receiving the control signal to control the startup signal during the brownout. In another aspect of the invention, the control circuit includes a capacitor having a first conduction terminal coupled for receiving the startup signal and a second conduction terminal coupled for receiving a ground reference potential.

In another aspect of the invention, the switching circuit includes a transistor having a control terminal coupled for receiving the control signal, a first conduction terminal coupled for receiving the startup signal, and a second conduction terminal coupled for receiving the ground reference potential.

In another aspect of the invention, the transistor includes a MOSFET. The MOSFET may be configured for receiving the control signal to short the startup signal to the ground reference potential during the brownout and to charge the capacitor with the startup signal during circuit startup and normal operation of the circuit.

In one aspect of the invention, a method provides for controlling a startup signal during a brownout, wherein the startup signal assists with power regulation. The method includes steps of monitoring an input signal, generating a control signal in response to a change in the input signal associated with the brownout, and electrically grounding the startup signal based on the control signal.

In another aspect of the invention, the step of monitoring includes a step of comparing the input signal to a reference signal to generate the control signal.

In another aspect of the invention, the method includes a step of generating the startup signal in response to receiving the input signal.

In another aspect of the invention, the method includes a step of operatively controlling a switch with the control signal to short the startup signal to a ground reference potential during the brownout.

In another aspect of the invention, the method includes a step of charging a charge storage device with the startup signal.

Advantages of the invention include an improved operating performance of devices during brownout occurrences. Other advantages include preventing undesirable triggers of over-current protection circuitry during the brownout occurrences.

### BRIEF DESCRIPTION OF THE PREFERRED EMBODIMENTS

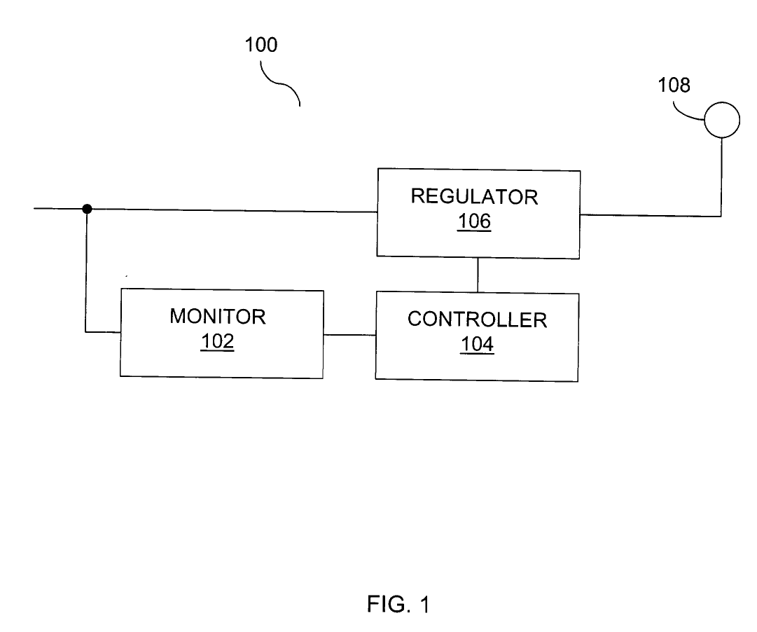

FIG. 1 is a block diagram illustrating an exemplary preferred embodiment of the invention.

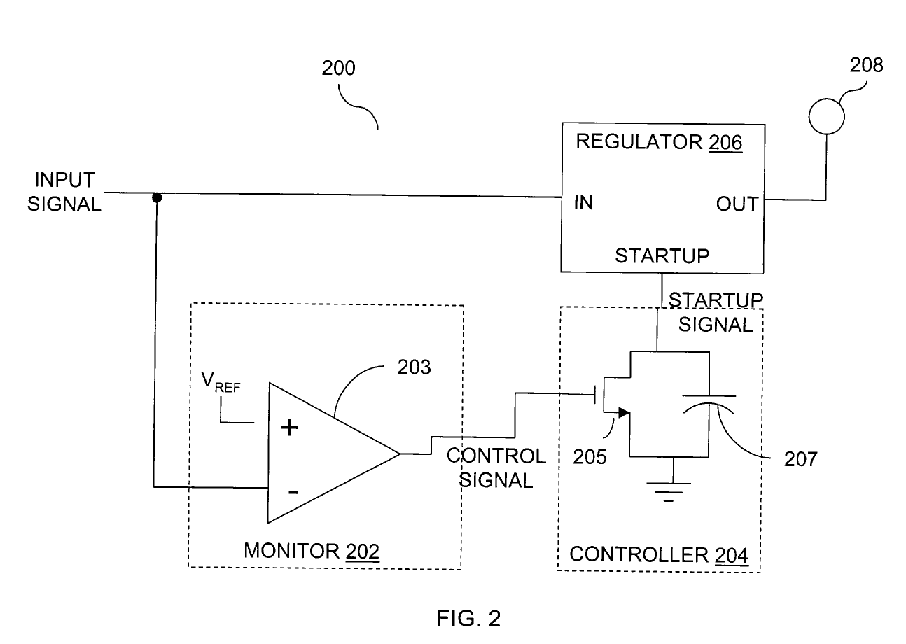

FIG. 2 is a schematic diagram illustrating an exemplary preferred embodiment of the invention.

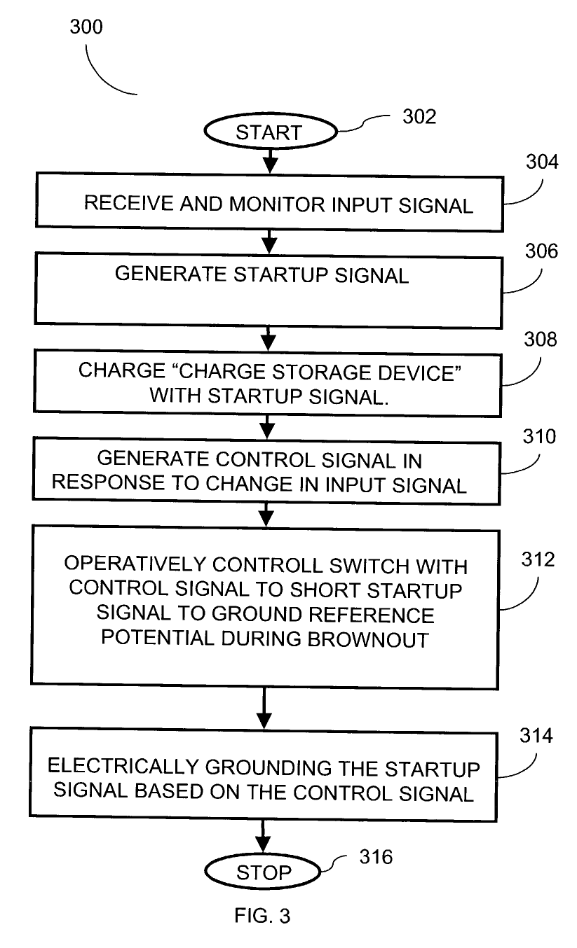

FIG. 3 is a flow chart diagram illustrating an exemplary preferred operation of the invention.

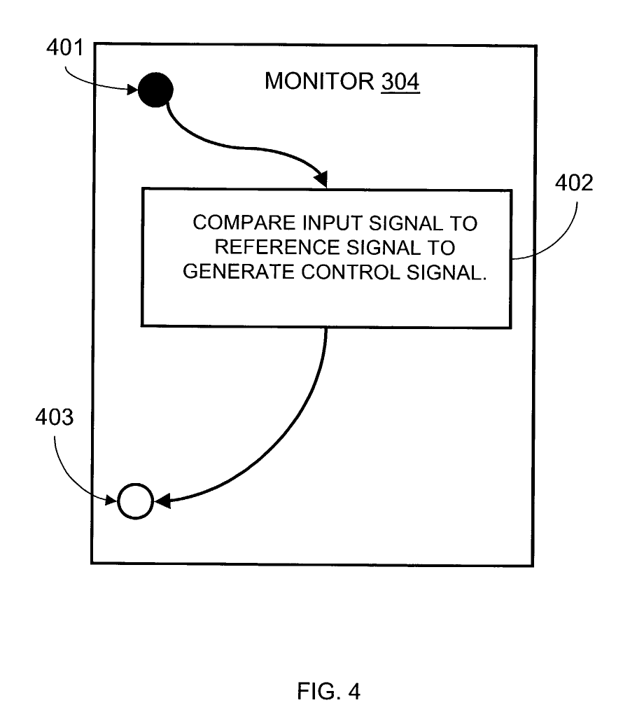

FIG. 4 is a flow chart diagram illustrating an exemplary preferred step of the operation of FIG. 3 of the invention.

### DETAILED DESCRIPTION OF THE PREFERRED EMBODIMENTS

While the invention is susceptible to various modifications and alternative forms, a specific embodiment thereof has been shown by way of example in the drawings and will herein be described in detail. Those skilled in the art will appreciate that the features described below can be combined in various ways to form multiple variations of the invention. As a result, the invention is not limited to the specific examples described below, but only by the claims and their equivalents.

With reference now to the figures and in particular with reference to FIG. 1, an exemplary preferred embodiment of the invention is shown in system 100. System 100 is configured to control a startup signal during a brownout. System 100 includes monitor 102 and controller 104. System 100 may additionally include regulator 106. In system 100, monitor 102 is configured for monitoring an input signal and for providing a control signal. In system 100, controller 104 is configured for receiving the control signal to control the startup signal during the brownout. In system 100, regulator 106 is configured for receiving the input signal and for providing the startup signal. The startup signal may assist with power regulation of a device that is electrically connected to the circuit at power plane 108. For example, as the device starts operating, or “turns on”, the device may draw current from regulator 106 to the extent as to create a current spike. The startup signal may be transferred to controller 104 to ease the current drawn by the device by controllably ramping the voltage from regulator 106 at power plane 108. The startup signal may be used with a soft-start feature of system 100. While system 100 may employ a soft-start feature using a startup signal, those skilled in the art will understand that other methods for easing the current and/or ramping voltage to a power plane may be used. Power plane 108 may be a power plane connection to an expansion board slot such that system 100 regulates power to a PCI card. However, system 100 may be used for regulating power to other types of devices and is not intended to be limited to the preferred embodiments shown herein.

FIG. 2 illustrates another exemplary preferred embodiment of the invention in circuit 200. Circuit 200 is configured to control a startup signal during a brownout. Circuit 200 may provide power to a device electrically connected to power plane 208. Circuit 200 includes monitor circuit 202 and controller circuit 204. Circuit 200 may additionally include signal regulator 206. In circuit 200, monitor circuit 202 may include operational amplifier 203. Operational amplifier 203 may function either as an operational amplifier or a comparator. Functional aspects of operational amplifiers and comparators are known by those skilled in the art. Operational amplifier 203 may have a non-inverting input coupled for receiving a reference voltage, V_{ref}, and an inverting input coupled for receiving an input signal to circuit 200. Operational amplifier 203 may compare the reference signal to the input signal to provide a control signal. A voltage level of the control signal may be related to the function of operational amplifier 203 (e.g., a discrete voltage level from the comparator or a continuous voltage level from the operational amplifier).

In circuit 200, controller 204 may include switching circuit 205 and capacitor 207. In circuit 200, switching circuit 205 may include a MOSFET having a control terminal coupled for receiving the control signal from operational amplifier 203. The MOSFET may have a first conduction terminal coupled for receiving the startup signal of regulator 206 and a second conduction terminal coupled for receiving a ground reference potential. For example, if switching circuit 205 includes an N-type MOSFET, the N-type MOSFET may have a gate coupled for receiving the control signal, a drain coupled for receiving the startup signal, and a source coupled for receiving the ground reference potential. Capacitor 207 may have a first conduction terminal coupled for receiving the startup signal and a second conduction terminal coupled for receiving the ground reference potential.

In circuit 200, signal regulator 206 is configured for receiving the input signal and for providing the startup signal. Signal regulator 206 may generate the startup signal as the device turns on and draws current from the circuit. The startup signal may charge capacitor 207 with a fixed current to controllably ramp up the output voltage of signal regulator 206 to power plane 208. Capacitor 207 may prevent the device from creating a current spike by controllably ramping the voltage. For example, as a device turns on and begins to draw current from circuit 200 through power plane 208, signal regulator 206 may charge capacitor 207 with current from the startup signal generated by a soft start feature of signal regulator 206. Once capacitor 207 is charged, the soft start feature of signal regulator 206 may disengage.

A brownout of power supplied to the device through power plane 208 may allow the device to create a current spike as power is restored and current is again rapidly drawn from signal regulator 206 by the device. Operational amplifier 203 may, therefore, detect the rapid current draw as a decrease in voltage of the input signal through the comparison of the voltage level of the input signal to that of V_{ref}. Operational amplifier 203 may output the control signal to control switching circuit 205. For example, as the voltage level of the input signal drops below that of V_{ref}, operational amplifier 203 may controllably operate switching circuit 205 to conduct the startup signal to the ground reference potential, thereby allowing capacitor 207 to discharge. The discharge of capacitor 207 may prevent a current spike associated with the brownout as the device attempts to draw excessive current. The current spike occurring during and/or after the brownout can trigger over-current protection circuitry of signal regulator 206 to completely shut down the device receiving power through power plane 208. Power plane 208 may be a power plane connection to an expansion board slot such that circuit 200 regulates power to a PCI card. However, circuit 200 may be used for regulating power to other types of devices and is not intended to be limited to the preferred embodiments shown herein.

FIG. 3 illustrates exemplary preferred operation 300 of circuit 200 of FIG. 2. Operation 300 commences, in step 302. Monitor circuit 202 receives and monitors the input signal, in step 304. Signal regulator 206 may generate a startup signal, in step 306. Signal regulator 206 charges a charge storage device, such as capacitor 207, with the startup signal, in step 308. The startup signal may, therefore, serve as a soft start feature of signal regulator 206 to controllably ramp up voltage of signal regulator 206, thereby assisting with power regulation to a device through power plane 208. Monitor circuit 202 may generate a control signal in response to a change in the input signal associated with the brownout, in step 310. Monitor circuit 202 may operatively control switching circuit 205 via operational amplifier 203 with the control signal to short the startup signal to a ground reference potential during the brownout, in step 312. Thus, switching circuit 204 may electrically ground the startup signal based on the control signal, in step 314. For example, as the voltage of the input signal drops below that of V_{ref}, operational amplifier 203 may controllably operate switching circuit 205 to conduct the startup signal to the ground reference potential, thereby allowing capacitor 207 to discharge. Operation 300 ends in step 316.

FIG. 4 illustrates an exemplary preferred embodiment of monitor step 304 of the operation of FIG. 3. Monitor step 304 enters through entry point 401. Operational amplifier 203 compares the voltage level of the input signal to that of V_{ref}, in step 402. Monitor step 304 exits through exit point 403.

Those skilled in the art will understand that other methods can be used to control a startup signal and/or a soft start feature of a signal regulator, such as signal regulator 206, that fall within the scope of the invention.

Instructions that perform the operations of FIGS. 3 and 4 can be stored on storage media. The instructions can be retrieved and executed by a microprocessor. Some examples of instructions are software, program code, and firmware. Some examples of storage media are memory devices, tapes, disks, integrated circuits, and servers. The instructions are operational when executed by the microprocessor to direct the microprocessor to operate in accord with the invention. Those skilled in the art are familiar with instructions and storage media.

Advantages of the preferred embodiments of the invention include an improved operating performance of devices during brownout occurrences. Other advantages include preventing undesirable triggers of over-current protection circuitry.

While the invention has been illustrated and described in the drawings and foregoing description, such illustration and description is to be considered as exemplary and not restrictive in character. One embodiment of the invention and minor variants thereof have been shown and described. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed:

1. A circuit for controlling a startup signal during a brownout, wherein the startup signal assists with power regulation, including:
a monitor circuit configured for monitoring an input signal to the circuit and having an output coupled for providing a control signal; and
a control circuit configured for receiving the control signal to control the startup signal during the brownout.

2. The circuit of claim 1, wherein the monitor circuit includes an operational amplifier having a first input coupled for receiving a reference signal, a second input coupled for receiving the input signal, and an output coupled for providing the control signal.

3. The circuit of claim 1, wherein the monitor circuit includes a comparator having a first input coupled for receiving a reference signal, a second input coupled for receiving the input signal, and an output coupled for providing the control signal.

4. The circuit of claim 1, further comprising a signal regulator having an input coupled for receiving the input signal and an output coupled for providing the startup signal.

5. The circuit of claim 1, wherein the control circuit includes:
a switching circuit having a first input coupled for receiving the startup signal, a second input coupled for receiving the control signal to control the startup signal during the brownout; and
a capacitor having a first conduction terminal coupled for receiving the startup signal and a second conduction terminal coupled for receiving a ground reference potential.

6. The circuit of claim 5, wherein the switching circuit includes a transistor having a control terminal coupled for receiving the control signal, a first conduction terminal coupled for receiving the startup signal, and a second conduction terminal coupled for receiving the ground reference potential.

7. The circuit of claim 6, wherein the transistor includes a MOSFET, the MOSFET configured for receiving the control signal to short the startup signal to the ground reference potential during the brownout and to charge the capacitor with the startup signal during circuit startup and normal operation of the circuit.

8. A system controlling a startup signal during a brownout, wherein the startup signal assists with power regulation, including:
a monitor configured for monitoring an input signal and for providing a control signal; and
a controller configured for receiving the control signal to control the startup signal during the brownout.

9. The system of claim 8, wherein the monitor includes an amplifier configured for receiving a reference signal and the input signal, and for providing the control signal in response to receiving the reference signal and the input signal.

10. The system of claim 8, wherein the monitor includes a comparator configured for receiving a reference signal and the input signal, and for providing the control signal in response to a comparison of the reference signal and the input signal.

11. The system of claim 8, further including a signal regulator configured for receiving the input signal and for providing the startup signal.

12. The system of claim 8, wherein the controller includes a switch configured for receiving the startup signal and for receiving the control signal to short the startup signal to a ground reference potential during the brownout.

13. A method for controlling a startup signal during a brownout, wherein the startup signal assists with power regulation, including steps of:
monitoring an input signal;
generating a control signal in response to a change in the input signal associated with the brownout; and
electrically grounding the startup signal based on the control signal.

14. The method of claim 13, the step of monitoring including a step of comparing the input signal to a reference signal to generate the control signal.

15. The method of claim 13, further including a step of generating the startup signal in response to receiving the input signal.

16. The method of claim 13, further including a step of operatively controlling a switch with the control signal to short the startup signal to a ground reference potential during the brownout.

17. The method of claim 13, further including a step of charging a charge storage device with the startup signal.
